(19) United States
(12) Patent Application Publication
(10) Pub. No.: US 2015/0279513 A1
(43) Pub. Date: Oct. 1, 2015

(54) MEDIUM- OR HIGH-VOLTAGE ELECTRICAL DEVICE

(71) Applicant: NEXANS, Paris (FR)

(72) Inventors: Christian Koelblin, Meximieux (FR); Matthias Meyer, Luebeck (DE)

(21) Appl. No.: 14/670,710

(22) Filed: Mar. 27, 2015

(30) Foreign Application Priority Data
Mar. 31, 2014 (FR) 14 00794

(51) Int. Cl. H01B 3/44; H01B 13/14

(52) U.S. Cl. CPC H01B 3/447; H01B 13/145; H01B 13/148

(57) ABSTRACT

An electrical device is provided having a crosslinked layer intended to surround or surrounding an elongated electrically conducting component, where the crosslinked layer is obtained from a polymer composition having at least one olefin polymer (A), and a crosslinking agent (B) having one or more oxazoline functional groups. The polymer A has one or more reactive functional groups capable of reacting with the oxazoline functional group of the crosslinking agent B.

The present invention relates to an electrical device of the electric cable or electric cable accessory type. It typically but not exclusively applies to the fields of low-voltage (in particular of less than 6 kV), medium-voltage (in particular from 6 to 45-60 kV) or high-voltage (in particular greater than 60 kV, and which can range up to 800 kV) power cables, whether they are direct current or alternating current.

Power cables typically comprise a central electrical conductor and at least one electrically insulating layer crosslinked by techniques well known to a person skilled in the art, in particular by the peroxide route.

The peroxide route is tending to be increasingly avoided with respect to the decomposition products of peroxide, which exhibit disadvantages during the manufacture of the cable, indeed even once the cable is in the operational configuration. This is because, during the crosslinking, the peroxides decompose and form crosslinking by-products, such as, in particular, methane, acetophenone, cumyl alcohol, acetone, tert-butanol, α-methylstyrene and/or water. The formation of water from cumyl alcohol is relatively slow and can occur after several months, indeed even a few years, once the cable is in the operational configuration. The risk of breakdown of the crosslinked layers is thus significantly increased. In addition, if the methane formed during the crosslinking stage is not discharged from the crosslinked layers, risks related to the explosiveness of methane and its ability to ignite cannot be ignored. This gas can also cause damage once the cable is put into service. Even if solutions exist for limiting the presence of methane within the cable, such as, for example, heat treating the cable in order to accelerate the diffusion of methane outside the cable, they become lengthy and expensive when the thickness of the crosslinked layers is high.

Mention may be made, as example of crosslinking process not using the peroxide route, of the document U.S. Pat. No. 4,826,726, which describes a heat-resistant electric cable comprising an elongated electrical conductor surrounded by a crosslinked layer obtained from a composition comprising an ethylenic copolymer comprising an oxirane functional group and a polymeric compound, as crosslinking agent, of the copolymer of ethylene and of unsaturated dicarboxylic acid anhydride type.

However, once said composition has been crosslinked, the layer obtained does not exhibit optimum properties of tensile strength and elongation at break, in particular during the life of the electric cable (cf. aging).

The aim of the present invention is to overcome the disadvantages of the techniques of the prior art by providing an electrical device, in particular of the electric cable or electric cable accessory type, comprising a crosslinked layer, the manufacture of which significantly limits the presence of crosslinking by-products, such as, for example, methane and/or water, while guaranteeing optimum mechanical properties (tensile strength and elongation at break) during the life of said electrical device.

A subject matter of the present invention is an electrical device, in particular of the electric cable or electric cable accessory type, comprising a crosslinked layer capable of surrounding or surrounding an elongated electrically conducting component, characterized in that the crosslinked layer is obtained from a polymer composition comprising:
at least one olefin polymer (A), and
a crosslinking agent (B) comprising one or more oxazoline functional groups,
   the olefin polymer (A) comprising one or more reactive functional groups capable of reacting with the oxazoline functional group of the crosslinking agent (B).

By virtue of the invention, the crosslinked layer makes it possible to avoid the use of organic peroxide while guaranteeing, on the one hand, a high level of crosslinking and, on the other hand, very good mechanical properties of the type consisting of tensile strength and elongation at break according to Standard NF EN 60811-1-1, during the life of the electrical device.

In addition, the crosslinked layer of the invention exhibits the advantage of being economical, easy to process, in particular by extrusion, and easy to manufacture since it does not require resorting to restrictive venting processes.

Olefin Polymer (A)

The olefin polymer of the invention comprises one or more reactive functional groups capable of reacting with the oxazoline functional group of the crosslinking agent B, in order to make possible the crosslinking of the polymer A.

Said reactive functional group will react directly with the oxazoline functional group after opening of the oxazoline during a rise in temperature.

The reactive functional group of the polymer A can be chosen from a carboxyl functional group, a precursor of the carboxyl functional group, such as, for example, an anhydride, an aromatic thiol functional group and a phenol functional group.

Thus, the chemical reaction between the reactive functional group of the polymer A of the carboxyl functional group type and the oxazoline functional group of the crosslinking agent B will make it possible to form a stable amide functional group covalently bonded to an ester functional group, the ester functional group originating from the reactive functional group of the polymer A and the amide functional group resulting from the oxazoline of the crosslinking agent B. This chemical crosslinking reaction can be illustrated as follows, under the action of heat (Δ):

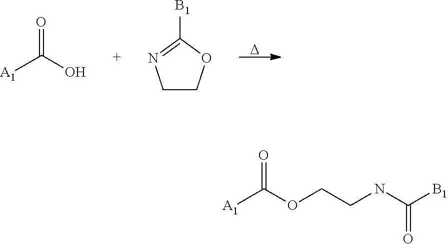

A₁ symbolizes the structure of the polymer A and B₁ symbolizes the structure of the crosslinking agent B.

During this crosslinking reaction, no toxic product is thus formed.

The polymer A of the invention can comprise at most 20% by weight of reactive functional group and preferably at most 10% by weight of reactive functional group, with respect to the total weight of the polymer A.

The polymer A of the invention can comprise at least 0.2% by weight of reactive functional group and preferably at least 1% by weight of reactive functional group, with respect to the total weight of the polymer A.

Of course, mixtures of different polymers A can be envisaged in the context of the invention, in particular with different amounts of reactive functional group.

The olefin polymer A (i.e., olefin polymer comprising one or more reactive functional groups capable of reacting with the oxazoline functional group of the crosslinking agent B) is obtained from the polymerization of at least one olefin monomer, said olefin monomer preferably being an ethylene monomer. Therefore, the olefin polymer A is preferably an ethylene polymer comprising one or more reactive functional groups capable of reacting with the oxazoline functional group of the crosslinking agent B.

The olefin polymer A can be of the thermoplastic or elastomer type.

Preferably, the olefin polymer A is of the thermoplastic type, in order to optimize the desired properties, in particular the electrical properties. Thermoplastic polymers conventionally have a melting point which can be easily determined by differential scanning calorimetry (or DSC) according to Standard ASTM D 3418.

The olefin polymer A can have a melt flow index (MFI) or a melt flow rate (MFR) of between 0.25 and 20 (limits included), preferably between 0.5 and 15 (limits included) and more preferably still between 5 and 12 (limits included), expressed in grams/10 minutes according to Standard ASTM D 1238 at 190° C./2.16 kg.

The temperature (i.e., 190° C.) and the weight (i.e., 2.16 kg) mentioned according to Standard ASTM D 1238 respectively refer to the temperature of the barrel and of the die of the measurement device and to the total weight of the piston with load which presses on the material to be measured in order to force it through the die of said device.

The term “polymer” is understood to mean any type of polymer well known to a person skilled in the art, such as, for example, homopolymer, copolymer, terpolymer, blocked copolymer, and the like.

The olefin polymer A can be based on an ethylene homopolymer or an ethylene copolymer chosen from high-density polyethylenes (HDPEs), medium-density polyethylenes (MDPEs), low-density polyethylenes (LDPEs), linear low-density polyethylenes (LLDPEs) and very-low-density polyethylenes (VLDPEs).

According to a first alternative form, the reactive functional group of the polymer A can be grafted to said polymer or more particularly to the macromolecular chain of the polymer A which is of the olefin polymer type.

The polymer A of the invention is, according to this first alternative form, a “grafted” polymer. Thus, the polymer A can be an olefin polymer comprising said reactive functional groups grafted to the polymer. In other words, the polymer according to the invention can be a polymer comprising at least one reactive functional group grafted to the macromolecular chain (i.e., main chain or backbone) of said polymer. For their part, the ends of the macromolecular chain of the polymer may or may not be grafted with said reactive functional group.

Mention may be made, by way of example, as polymer A of the first alternative form, of polyethylene grafted with maleic anhydride.

According to a second alternative form, the polymer A of the invention can be a copolymer of olefin and of a monomer carrying the reactive functional group. In other words, the polymer A can be a copolymer obtained from the polymerization of at least two monomers, one being an olefin and the other being a monomer comprising said reactive functional group. Said monomer comprising said reactive functional group can be chosen from unsaturated carboxylic acid monomers comprising in particular a carbon-carbon double bond, such as, for example, acrylic acid, methacrylic acid, maleic acid, fumaric acid, crotonic acid, isocrotonic acid, tiglic acid, vinylacetic acid, 2-pentenoic acid, 3-pentenoic acid, allylacetic acid, angelic acid, citraconic acid or mesaconic acid monomers.

Mention may be made, by way of example, of copolymers of ethylene and methacrylic acid or copolymers of ethylene and acrylic acid.

Terpolymers, or in other words copolymers obtained from three monomers, can also be envisaged in the context of the invention. In this case, the polymer A can be a copolymer obtained from the polymerization of three different monomers, the first being an olefin and the second and the third being monomers comprising said reactive functional group. Said monomers comprising said reactive functional group can be chosen independently from unsaturated carboxylic acid monomers and their derivatives comprising in particular a carbon-carbon double bond, such as, for example, acrylic acid, methacrylic acid, maleic acid, fumaric acid, crotonic acid, isocrotonic acid, tiglic acid, vinylacetic acid, 2-pentenoic acid, 3-pentenoic acid, allylacetic acid, angelic acid, citraconic acid or mesaconic acid monomers.

Mention may be made, by way of example, of terpolymers of ethylene, methacrylic acid and acrylic acid.

The melting point of the polymers A of the present invention can be between 80 and 170° C., preferably between and 120° C. and preferably between 90 and 115° C. The melting point of a polymer is conventionally measured at the melting peak of said polymer by differential scanning calorimetry (DSC) with a temperature gradient of 20° C./min under a nitrogen atmosphere.

The polymer A of the invention is a polymer which makes it possible to be shaped by extrusion.

The polymer A of the invention can be of the olefin homopolymer or copolymer type. Preferably, said olefin polymer is a noncyclic olefin polymer.

In the present invention, preference will be given to the use of an ethylene polymer (ethylene homo- or copolymer) or a propylene polymer (propylene homo- or copolymer).

According to the first alternative form of the invention described above, use may be made of an olefin homopolymer grafted with a reactive functional group or an olefin copolymer grafted with a reactive functional group, it being possible for the reactive functional group to preferably be a carboxyl functional group.

According to the second alternative form of the invention described above, use may be made of a copolymer obtained from an olefin monomer and a monomer comprising at least one reactive functional group.

The polymer composition of the invention can comprise more than 50.0 parts by weight of polymer A per 100 parts by weight of polymer(s) (i.e., polymer matrix) in the polymer composition, preferably at least 70 parts by weight of polymer A per 100 parts by weight of polymer(s) in said polymer composition, preferably at least 90 parts by weight of polymer A per 100 parts by weight of polymer(s) in said polymer composition and particularly preferably only one or more polymers A.

In the present invention, the olefin polymer A is preferably not a polyacrylate. More particularly, the polymer A does not comprise an ester functional group of the general formula RCOOR′. This is because ester functional groups are not at all advantageous for the mechanical properties desired in the field of cable manufacture of the invention.

Polyacrylates are typically obtained by the polymerization of acrylic ester(s), in particular in the presence of olefin monomer.

In the case where the polyacrylate is obtained without the presence of olefin monomer, the olefin polymer A is clearly different from the polyacrylate, since the olefin polymer A is obtained by polymerization starting from at least one olefin monomer.

Mention may be made, as examples of polyacrylates, to alkyl acrylate copolymers.

Polyacrylates thus have all pendant ester functional groups on their macromolecular chain, these functional groups preferably not coming within the scope of the invention.

This is because the polyacrylates described above are not at all advantageous for the mechanical properties desired in the field of cable manufacture of the invention.

In a specific embodiment, the polymer composition can comprise less than 10 parts by weight of polyacrylate, and preferably less than 5 parts by weight of polyacrylate, per 100 parts by weight of polymer(s) in the composition. Preferably, the polymer composition does not comprise polyacrylate. More particularly, the device of the invention does not comprise polyacrylate.

In the present invention, the olefin polymer A is preferably not a polyimide. More particularly, the polymer A does not comprise an imide functional group of general formula (RCO)₂NR′. This is because imide functional groups are not at all advantageous for the mechanical properties desired in the field of cable manufacture of the invention.

In a specific embodiment, the polymer composition can comprise less than 10 parts by weight of polyimide and preferably less than 5 parts by weight of polyimide, per 100 parts by weight of polymer(s) in the composition. Preferably, the polymer composition does not comprise polyimide. More particularly, the device of the invention does not comprise polyimide.

Furthermore, the polymer composition can comprise less than 10 parts by weight of fluoropolymer and preferably less than 5 parts by weight of fluoropolymer per 100 parts by weight of polymer(s) in the composition. Preferably, the polymer composition does not comprise fluoropolymer. More particularly, the device of the invention does not comprise fluoropolymer.

In the present invention, when reference is made to “100 parts by weight of polymer(s)”, this is preferably understood to mean the polymer or polymers other than the crosslinking agent B in the polymer composition (when the crosslinking agent B is in the polymer form).

Particularly advantageously, the constituent polymer or polymers of the polymer composition (i.e., the polymer matrix) are solely one or more olefin-based polymer(s).

The polymer composition of the invention can comprise at least 40.0% by weight of polymer(s) and preferably at least 50.0% by weight of polymer(s), with respect to the total weight of the polymer composition, thus forming the polymer matrix of the invention. Preferably, the polymer composition of the invention can comprise at most 99.8% by weight of polymer(s) and preferably at most 96.0% by weight of polymer(s) with respect to the total weight of the polymer composition.

In the present invention, the polymer matrix in particular does not include the crosslinking agent B when it is in the form of a polymer.

Crosslinking Agent (B)

The crosslinking agent B of the invention comprises at least two reactive functional groups intended to react with the reactive functional group or groups of the olefin polymer A. At least one of these two reactive functional groups is an oxazoline functional group. Preferably, the crosslinking agent B can comprise at least two oxazoline functional groups.

The crosslinking agent B of the invention can be a polymeric compound or a nonpolymeric compound. Preferably, the crosslinking agent is other than polymer A.

The oxazoline functional group is a functional group, the general formula (I) of which is as follows:

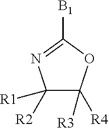

B₁ symbolizes the structure of the crosslinking agent B which carries at least one of this oxazoline functional group.

B₁ can thus be the macromolecular chain of a polymer or a nonpolymeric compound of aliphatic or aromatic type.

The oxazoline functional group can be covalently attached to B₁ by a carbon unit, an ether unit, an ester unit, a urethane unit or a heteroatom of the nitrogen, phosphorus or sulfur type.

R1, R2, R3 and R4 can be chosen, independently of one another, from a hydrogen atom and an alkyl group. Preferably, R1, R2, R3 and R4 are hydrogens.

When the crosslinking agent of the invention is of the “nonpolymeric” type, it does not result from the covalent linking of a large number of identical or different monomer units and preferably it does not result from the covalent linking of at least two identical or different monomer units.

In a first embodiment in which the crosslinking agent is a polymeric compound, the crosslinking agent is a copolymer functionalized with oxazoline functional groups. Mention may be made, by way of example, of the copolymer sold by Nippon Sokubai under the Epocros reference.

In a second embodiment in which the crosslinking agent is a nonpolymeric compound, the crosslinking agent comprises at least two oxazoline functional groups.

Mention may be made, as nonpolymeric compound comprising two oxazoline functional groups, of bisoxazolines, such as, for example 2,2′-(1,3-phenylene)bis(2-oxazoline) (1,3-PBO), 2,2′-(1,4-phenylene)bis(2-oxazoline) (1,4-PBO) or 2,2′-(2,6-pyridylene)bis(2-oxazoline) (pybox).

When the nonpolymeric crosslinking agent comprises more than two oxazoline functional groups, mention may be made, for example, of compounds comprising three oxazoline functional groups, such as 2,2′,2″-(1,3,5-phenylene)tris(2-oxazoline) or 2,2′,2″-(1,2,4-phenylene)tris(5-methyl-2-oxazoline).

The oxazoline functional group of the crosslinking agent (B) is capable of reacting with the reactive functional group of the polymer to make possible the crosslinking of the olefin polymer (A).

The crosslinking agent is preferably in the powder form in order to facilitate the metering thereof when it is employed by extrusion.

Conventionally, the crosslinking kinetics relative to the crosslinking agent and more particularly the opening of the oxazoline ring are a function of the temperature of the reaction medium. By way of example, the crosslinking can be carried out at temperatures of at least 70° C., preferably of between 70 and 120° C. and preferably of between 80 and 100° C., these temperatures being in particular well suited for the processing of the polymer composition of the invention by extrusion.

A temperature of less than 70° C. can be used but the crosslinking will be relatively slow.

A temperature of greater than 200° C. at a pressure greater than atmospheric pressure, for a few minutes, can in addition also be used for crosslinking of the polymer composition of the invention, such as, for example, a temperature of between 250 and 350° C., in particular at a pressure of 10 bar. These conditions are those typical of the crosslinking conditions using a continuous vulcanization line (CV line), in particular a steam or nitrogen line, for the cable production.

Preferably, the crosslinking agent B has a melting point greater than the melting point of the polymer A. The melting point of the crosslinking agent B is conventionally measured at the melting peak of said crosslinking agent by differential scanning calorimetry (DSC) with a temperature gradient of 10° C./min under a nitrogen atmosphere.

By way of example, the melting point:
of 2,2′-(1,3-phenylene)bis(2-oxazoline) (1,3-PBO) is approximately 148° C.;
of 2,2′-(1,4-phenylene)bis(2-oxazoline) (1,4-PBO) is approximately 242° C.; and
of 2,2′-(2,6-pyridylene)bis(2-oxazoline) (pybox) is approximately 157° C.

The polymer composition in accordance with the invention can comprise a sufficient amount of crosslinking agent B to be able to carry out the crosslinking of the polymer A.

The polymer composition in accordance with the invention can comprise at most 20.0 parts by weight of crosslinking agent B per 100 parts by weight of polymer(s) in the composition, and preferably at most 15.0 parts by weight of crosslinking agent B per 100 parts by weight of polymer(s) in the composition.

The polymer composition in accordance with the invention can comprise at least 0.1 part by weight of crosslinking agent B per 100 parts by weight of polymer(s) in the composition and preferably at least 5 parts by weight of crosslinking agent B per 100 parts by weight of polymer(s) in the composition.

In the present invention, when reference is made to “100 parts by weight of polymer(s)”, this is preferably understood to mean the polymer or polymers other than the crosslinking agent B (when the crosslinking agent B is in the polymer form).

The polymer composition of the invention can comprise at most 20% by weight of crosslinking agent B with respect to the total weight of the polymer composition.

The polymer composition of the invention can comprise at least 0.1% by weight of crosslinking agent B with respect to the total weight of the polymer composition.

Filler-Comprising Polymer Composition

The polymer composition of the invention can additionally comprise one or more fillers.

The filler of the invention can be an inorganic or organic filler. It can be chosen from a flame-retardant filler and an inert filler (or noncombustible filler).

By way of example, the flame-retardant filler can be a hydrated filler chosen in particular from metal hydroxides, such as, for example, magnesium dihydroxide (MDH) or aluminum trihydroxide (ATH). These flame-retardant fillers act mainly by the physical route by decomposing endothermically (e.g., release of water), which has the consequence of lowering the temperature of the crosslinked layer and of limiting the propagation of the flames along the electrical device. The term flame retardant properties is used in particular.

For its part, the inert filler can be chalk, talc, clay (e.g., kaoline), carbon black or carbon nanotubes.

The filler can also be an electrically conducting filler chosen in particular from carbon-based fillers. Mention may be made, by way of example, as electrically conducting filler, of carbon blacks, graphenes or carbon nanotubes.

According to a first alternative form, the electrically conducting filler may be preferred in order to obtain a crosslinked “semiconducting” layer and may be introduced into the polymer composition in an amount sufficient to render the composition semiconducting, this amount varying according to the type of electrically conducting filler selected. By way of example, the appropriate amount of the electrically conducting filler can be between 8 and 40% by weight in the polymer composition for carbon black and can be from 0.1 to 5% by weight in the polymer composition for carbon nanotubes.

According to a second alternative form, the electrically conducting filler may be preferred in order to obtain a crosslinked “electrically insulating” layer and may be used in a small amount in order to improve the dielectric properties of an electrically insulating layer, without it becoming semiconducting.

The polymer composition can comprise at least 1% by weight of filler(s), preferably at least 10% by weight of filler(s), and preferably at most 50% by weight of filler(s) with respect to the total weight of the polymer composition.

According to another characteristic of the invention and in order to guarantee an “HFFR” (Halogen-Free Flame Retardant) electrical device, the electrical device, or in other words the components which make up said electrical device, preferably does/do not comprise haloganted compounds. The term more generally used is a “halogen-free” device. These halogenated compounds can be of any nature, such as, for example, fluoropolymers or chloropolymers, such as polyvinyl chloride (PVC), halogenated plasticizers, halogenated inorganic fillers, and the like.

Additives

In addition, the composition can typically comprise additives in an amount of 0.1 to 20% by weight in the polymer composition.

The additives are well known to a person skilled in the art and can, for example, be chosen from:
protective agents, such as antioxidants, UV stabilizers, agents for combating copper or agents for combating water treeing,
processing aids, such as plasticizers, viscosity reducers or oils,
compatibilizing agents,
coupling agents,
scorch retardants,
pigments,
crosslinking catalysts,
agents which modify the crosslinking rate;
and one of their mixtures.

More particularly, the antioxidants make it possible to protect the composition from the thermal stresses brought about during the stages of manufacture of the device or of operation of the device.

The antioxidants are preferably chosen from:
sterically hindered phenolic antioxidants, such as tetrakis[methylene(3,5-di(t-butyl)-4-hydroxyhydro-cinnamate)]methane, octadecyl 3-(3,5-di(t-butyl)-4-hydroxyphenyl)propionate, 2,2′-thiodiethylenebis[3-(3,5-di(t-butyl)-4-hydroxyphenyl)propionate], 2,2′-thiobis(6-(t-butyl)-4-methylphenol), 2,2′-methylenebis(6-(t-butyl)-4-methylphenol), 1,2-bis(3,5-di(t-butyl)-4-hydroxyhydrocinnamoyl)hydrazine, and 2,2′-oxamidodiethyl bis[3-(3,5-di(t-butyl)-4-hydroxyphenyl)propionate];
thioethers, such as 4,6-bis(octylthiomethyl)-o-cresol, bis[2-methyl-4-{3-(n-(C₁₂ or C₁₄)alkylthio)-propionyloxy}-5-(t-butyl)phenyl]sulfide and thiobis[2-(t-butyl)-5-methyl-4,1-phenylene]bis[3-(dodecylthio)propionate];
sulfur-based antioxidants, such as dioctadecyl 3,3′-thiodipropionate or didodecyl 3,3′-thiodipropionate;
phosphorus-based antioxidants, such as phosphites or phosphonates, such as, for example, tris[2,4-di(t-butyl)phenyl]phosphite or bis[2,4-di(t-butyl)phenyl]pentaerythritol diphosphite; and
amine-type antioxidants, such as phenylenediamines (IPPD, 6PPD, and the like), styrenated diphenylamines, diphenylamines, mercaptobenzimidazoles and polymerized 2,2,4-trimethyl-1,2-dihydroquinoline (TMQ), the latter type of antioxidant being particularly preferred in the composition of the invention.

The TMQs can have different grades, namely:
a “standard” grade with a low degree of polymerization, that is to say with a residual monomer content of greater than 1% by weight and having a residual NaCl content which can range from 100 ppm to more than 800 ppm (parts per million by weight);
a “high degree of polymerization” grade with a high degree of polymerization, that is to say with a residual monomer content of less than 1% by weight and having a residual NaCl content which can range from 100 ppm to more than 800 ppm;
a “low content of residual salt” grade with a residual NaCl content of less than 100 ppm.

TMQ-type antioxidants are preferably used when the polymer composition comprises electrically conducting fillers.

The type of stabilizing agent and its content in the composition of the invention are conventionally chosen according to the maximum temperature to which the polymers are subjected during the production of the mixture and during their processing, in particular by extrusion, and also according to the maximum duration of exposure to this temperature.

The purpose of the crosslinking catalysts is to help in the crosslinking. The crosslinking catalyst can be chosen from Lewis acids, Brönsted acids and tin-based catalysts, such as, for example, dibutyltin dilaurate (DBTL).

The agents which modify the crosslinking rate can react with the oxazoline functional group to form a modified oxazoline functional group. They can be polyfunctional molecules comprising at least three functional groups independently chosen from carboxyl, phenol and aromatic thiol functional groups.

The Crosslinked Layer and the Electrical Device

In the present invention, the crosslinked layer can be easily characterized by the determination of its gel content according to Standard ASTM D2765-01.

More particularly, said crosslinked layer can advantageously have a gel content, according to Standard ASTM D2765-01 (extraction with xylene), of at least 50%, preferably of at least 70%, preferably at least 80% and particularly preferably of at least 90%.

The crosslinked layer of the invention can be chosen from an electrically insulating layer, a semiconducting layer, a stuffing component and a protective sheath. The device of the invention can, of course, comprise combinations of at least two of these four types of crosslinked layer. The crosslinked layer of the invention can be the outermost layer of the electrical device.

In the present invention, “electrically insulating layer” is understood to mean a layer, the electrical conductivity of which can be at most 1·10⁻⁹ S/m (siemens per meter) (at 25° C.)

When the crosslinked layer of the invention is an electrically insulating layer, the polymer composition of the invention can comprise at least 70% by weight of polymer A, with respect to the total weight of the polymer composition, thus forming the polymer matrix of the invention.

In the present invention, “semiconducting layer” is understood to mean a layer, the electrical conductivity of which can be at least 1·10⁻⁹ S/m (siemens per meter), preferably at least 1·10⁻³ S/m, and preferably can be less than 1·10³ S/m (at 25° C.).

When the crosslinked layer of the invention is a semiconducting layer, the polymer composition of the invention can comprise an electrically conducting filler in an amount sufficient to render the crosslinked layer of the invention semiconducting.

The crosslinked layer of the invention can be a layer extruded or a layer molded by processes well known to a person skilled in the art.

The electrical device of the invention can be an electric cable or an electric cable accessory.

According to a first embodiment, the device according to the invention is an electric cable comprising said crosslinked layer surrounding said elongated electrically conducting component.

When the electrical device is an electric cable, the crosslinked layer is preferably a layer extruded by techniques well known to a person skilled in the art.

The crosslinked layer of the invention can surround the elongated electrically conducting component according to several alternative forms.

According to a first alternative form, the crosslinked layer can be directly in physical contact with the elongated electrically conducting component. Reference is made, in this first alternative form, to low-voltage cable.

According to a second alternative form, the crosslinked layer can be at least one of the layers of an insulating system comprising:
a first semiconducting layer surrounding the electrically conducting component,
an electrically insulating layer surrounding the first semiconducting layer, and
a second semiconducting layer surrounding the electrically insulating layer.

Reference is made, in this second alternative form, to medium- or high-voltage cable.

According to a second embodiment, the device according to the invention is an electric cable accessory, said accessory comprising said crosslinked layer.

Said accessory is intended to surround or surrounds the elongated electrically conducting component of an electric cable. More particularly, said accessory is intended to surround or surrounds an electric cable and it is preferably intended to surround or surrounds at least one end of an electric cable. The accessory can in particular be an electric cable joint or termination.

The accessory can typically be a hollow longitudinal body, such as, for example, an electric cable joint or termination, in which at least a portion of an electric cable is intended to be positioned.

The accessory comprises at least one semiconducting component and at least one electrically insulating component, these components being intended to surround an end of an electric cable. The semiconducting component is well known for controlling the geometry of the electric field, when the electric cable, in combination with said accessory, is under voltage.

The crosslinked layer of the invention can be said semiconducting component and/or said electrically insulating component of the accessory.

When the accessory is a joint, the latter makes it possible to connect together two electric cables, the joint then being intended to surround or surrounding, at least in part, these two electric cables. More particularly, the end of each electric cable intended to be connected is positioned inside said joint.

When the device of the invention is an electric cable termination, the termination is intended to surround or surrounds, at least in part, an electric cable. More particularly, the end of the electric cable intended to be connected is positioned inside said termination.

When the electric device is an electric cable accessory, the crosslinked layer is preferably a layer molded by techniques well known to a person skilled in the art.

In the present invention, the elongated electrically conducting component of the electric cable can be a metal wire or a plurality of metal wires, which is/are or is/are not twisted, in particular made of copper and/or of aluminum, or one of their alloys.

Another subject matter of the invention is a process for the manufacture of an electric cable according to the invention, characterized in that it comprises the following stages:
i. extruding the polymer composition around an elongated electrically conducting component, in order to obtain an extruded layer, and
ii. crosslinking the extruded layer of stage i.

Stage i can be carried out by techniques well known to a person skilled in the art, using an extruder.

During stage i, the composition at the extruder outlet is “noncrosslinked”, the temperature and also the time of processing within the extruder being consequently optimized.

“Noncrosslinked” is understood to mean a layer, the gel content of which according to Standard ASTM D2765-01 (extraction with xylene) is at most 20%, preferably at most 10%, preferably at most 5% and particularly preferably 0%.

There is thus obtained, at the extruder outlet, a layer extruded around said electrically conducting component which may or may not be directly in physical contact with said electrically conducting component.

Prior to stage i, the constituent components of the polymer composition of the invention can be mixed, in particular with polymer A in the molten state, in order to obtain a homogeneous mixture. The temperature within the mixer can be sufficient to obtain a polymer A in the molten state but is limited in order to prevent the opening of the oxazoline functional group of the crosslinking agent B and thus the crosslinking of the polymer A. The homogeneous mixture is then granulated by techniques well known to a person skilled in the art. These granules can subsequently feed an extruder in order to carry out stage i.

During the extrusion in stage i and/or the preliminary mixing stage, the processing temperature within the extruder and/or the mixer can be conventionally greater than or equal to the melting point of the crosslinking agent B, it being known in particular that the melting point of the polymer A is preferably lower than the melting point of the crosslinking agent B.

For this reason, the crosslinking agent B can be mixed particularly homogeneously with the polymer A.

In a particularly preferred embodiment, during the extrusion stage i and/or the preliminary mixing stage, the processing temperature within the extruder and/or the mixer can advantageously be:
equal to that of the melting point of the crosslinking agent B, or else
at most equal to the melting point of the crosslinking agent B plus 10° C. and preferably at most equal to the melting point of the crosslinking agent B plus 5° C.,
   it being known in particular that the melting point of the polymer A is preferably less than the melting point of the crosslinking agent B.

For this reason, the crosslinking agent B can be homogeneously mixed with the polymer A while significantly limiting, indeed even avoiding, any reaction of the crosslinking agent B with the polymer A.

Mention may be made, by way of example, of 1,3-PBO, which has a melting point of approximately 148° C. For this reason, the maximum extrusion and/or mixing temperature is preferably at most 158° C.

Stage ii can be carried out by the thermal route, for example using a continuous vulcanization line (CV line), a steam tube, a bath of molten salt, an oven or a thermal chamber, these techniques being well known to a person skilled in the art.

Stage ii thus makes it possible to obtain a crosslinked layer having in particular a gel content, according to Standard ASTM D2765-01, of at least 40%, preferably of at least 50%, preferably of at least 60% and particularly preferably of at least 70%.

At the extruder outlet, the composition extruded in the form of a layer around the electrically conducting component can subsequently be subjected to a sufficient temperature and for a sufficient time to be able to obtain the desired crosslinking by the reaction of the reactive functional groups of the polymer A with the open oxazoline functional groups. An extruded and crosslinked layer is then obtained.

Another subject matter of the invention is a process for the manufacture of an electric cable accessory, characterized in that it comprises the following stages:

i. molding the polymer composition intended to surround an elongated electrically conducting component in order to obtain a molded layer, and

ii. crosslinking the molded layer of stage i.

Stage i can be carried out by techniques well known to a person skilled in the art, in particular by molding or extrusion-molding.

The constituent compounds of the polymer composition of the invention can be mixed prior to stage i, as described above for the manufacture of a cable.

Stage ii can be carried out by the thermal route, for example using a heating mold, which can be the mold used in stage i.

Stage ii thus makes it possible to obtain a crosslinked layer having in particular a gel content, according to Standard ASTM D2765-01, of at least 40%, preferably of at least 50%, preferably of at least 60% and particularly preferably of at least 70%.

The composition of stage i can subsequently be subjected, in the mold, to a sufficient temperature and for a sufficient time to be able to obtain the desired crosslinking by the reaction of the reactive functional groups of the polymer A with the open oxazoline functional groups. A molded and crosslinked layer is then obtained.

In the present invention, the crosslinking temperature and the crosslinking time of the extruded and/or molded layer employed are in particular functions of the thickness of the layer, of the number of layers, of the presence or not of a crosslinking catalyst, and the like.

A person skilled in the art may easily determine these parameters by monitoring the change in the crosslinking by virtue of the determination of the gel content according to Standard ASTM D2765-01 in order to obtain a crosslinked layer.

When an extruder is used, the temperature profile of the extruder and the extrusion rate are parameters which a person skilled in the art may also vary in order to guarantee that the desired properties are obtained.

Other characteristics and advantages of the present invention will become apparent in the light of the description of nonlimiting examples of an electric cable according to the invention and electric cable accessory according to the invention, made with reference to the figures.

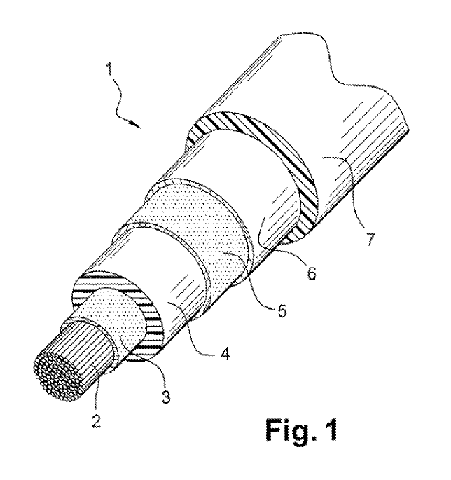

FIG. 1 represents a diagrammatic view in cross section of an electric cable according to a preferred embodiment in accordance with the invention.

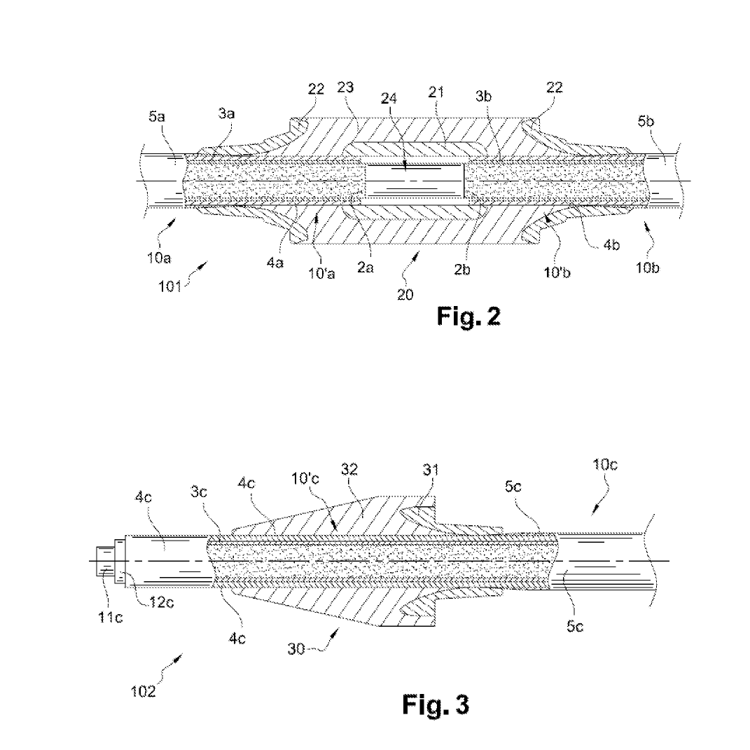

FIG. 2 represents a diagrammatic view of an electric device according to the invention comprising a joint in longitudinal section, this joint surrounding the ends of two electric cables.

FIG. 3 represents a diagrammatic view of an electric device according to a first alternative form of the invention comprising a termination in longitudinal section, this termination surrounding the end of a single electric cable.

For reasons of clarity, only the components essential for the understanding of the invention have been represented diagrammatically, this being done without observing a scale.

The medium- or high-voltage power cable 1, illustrated in FIG. 1, comprises an elongated central conducting component 2, in particular made of copper or of aluminum. The power cable 1 additionally comprises several layers positioned successively and coaxially around this conducting component 2, namely: a first semiconducting layer 3 referred to as “inner semiconducting layer”, an electrically insulating layer 4, a second semiconducting layer 5 referred to as “outer semiconducting layer”, an earthing and/or protective metal shield 6 and an external protective sheath 7.

The electrically insulating layer 4 is an extruded and crosslinked layer obtained from the polymer composition according to the invention.

The semiconducting layers are also extruded and crosslinked layers which can be obtained from the polymer composition according to the invention.

The presence of the metal shield 6 and of the external protective sheath 7 is preferential but not essential, this cable structure being as such well known to a person skilled in the art.

FIG. 2 represents a device 101 comprising a joint 20 surrounding, in part, two electric cables 10a and 10b.

More particularly, the electric cables 10a and 10b respectively comprise an end 10′a and 10′b which are intended to be surrounded by the joint 20.

The body of the joint 20 comprises a first semiconducting component 21 and a second semiconducting component 22 separated by an electrically insulating component 23, said semiconducting components 21, 22 and said electrically insulating component 23 surround the ends 10′a and 10′b respectively of the electric cables 10a and 10b.

This joint 20 makes it possible to electrically connect the first cable 10a to the second cable 10b, in particular by virtue of an electrical connector 24 positioned at the center of the joint 20.

At least one of the components chosen from the first semiconducting component 21, the second semiconducting component 22 and said electrically insulating component 23 can be a crosslinked layer as described in the invention.

The first electric cable 10a comprises an electrical conductor 2a surrounded by a first semiconducting layer 3a, an electrically insulating layer 4a surrounding the first semiconducting layer 3a, and a second semiconducting layer 5a surrounding the electrically insulating layer 4a.

The second electric cable 10b comprises an electrical conductor 2b surrounded by at least one first semiconducting layer 3b, an electrically insulating layer 4b surrounding the first semiconducting layer 3b, and a second semiconducting layer 5b surrounding the electrically insulating layer 4b.

These electric cables 10a and 10b can be those described in the present invention.

At said end 10′a, 10′b of each electric cable 10a, 10b, the second semiconducting layer 5a, 5b is at least partially denuded in order for the electrically insulating layer 4a, 4b to be at least partially positioned inside the joint 20, without being covered with the second semiconducting layer 5a, 5b of the cable.

Inside the joint 20, the electrically insulating layers 4a, 4b are directly in physical contact with the electrically insulating component 23 and the first semiconducting component 21 of the joint 20. The second semiconducting layers 5a, 5b are directly in physical contact with the second semiconducting component 22 of the joint 20.

FIG. 3 represents a device 102 comprising a termination 30 surrounding a single electric cable 10c.

More particularly, the electric cable 10c comprises an end 10′c intended to be surrounded by the termination 30.

The body of the termination 30 comprises a semiconducting component 31 and an electrically insulating component 32, said semiconducting component 31 and said electrically insulating component 32 surrounding the end 10′c of the electric cable 10c.

At least one of the components chosen from the semiconducting component 31 and the electrically insulating component 32 can be a crosslinked layer as described in the invention.

The electric cable 10c comprises an electrical conductor 2c surrounded by a first semiconducting layer 3c, an electrically insulating layer 4c surrounding the first semiconducting layer 3c, and a second semiconducting layer 5c surrounding the electrically insulating layer 4c.

This electric cable 10c can be that described in the present invention.

At said end 10′c of the electric cable 10c, the second semiconducting layer 5c is at least partially denuded in order for the electrical insulating layer 4c to be at least partially positioned inside the termination 30, without being covered with the second semiconducting layer 5c of the cable.

Inside the termination 30, the electrically insulating layer 4c is directly in physical contact with the electrically insulating component 32 of the termination 30. The second semiconducting layer 5c is directly in physical contact with the semiconducting component 31 of the joint 30.

### Examples of Polymer Compositions According to the Invention, in Order to Obtain an Electrically Insulating Crosslinked Layer

70-99.8% by weight of polymer A,

0.2-20% by weight of crosslinking agent B,

0-4% by weight of a crosslinking catalyst,

0-5% by weight of an antioxidant,

0-20% by weight of an oil,

0-5% by weight of an agent for combating water treeing, and

0-5% by weight of agent which modifies the crosslinking rate.

### Examples of Polymer Compositions According to the Invention, in Order to Obtain a Semiconducting Crosslinked Layer

55-98% by weight of polymer A,
0.2-20% by weight of crosslinking agent B,
0-4% by weight of a crosslinking catalyst,
8-40% by weight of an electrically conducting filler of the carbon black type, with 0-5% by weight of carbon nanotubes,
0-5% by weight of an antioxidant,
0-20% by weight of an oil, and
0-5% by weight of agent which modifies the crosslinking rate.

### Characterization of the Mechanical Properties of Filler-Free Electrically Insulating Compositions

Filler-free polymer compositions are collated in Table 1 below, the amounts of the compounds of which compositions are expressed as percentages (%) by weight in the polymer composition.

The polymer matrix in these polymer compositions comprises a single olefin polymer A (A1, A2, A3 or A4).

The compositions C1 to C6 are in accordance with the invention, while the composition Ref1 corresponds to a reference composition.

TABLE 1

| | Polymer | Polymer | Polymer | Polymer | | |
|---|---|---|---|---|---|---|
| | A1 | A2 | A3 | A4 | Agent B | Catalyst |
| | (% by | (% by | (% by | (% by | (% by | (% by |
| Composition | weight) | weight) | weight) | weight) | weight) | weight) |
| Ref1 | 100 | 0 | 0 | 0 | 0 | 0 |
| C1 | 94.0 | 0 | 0 | 0 | 6.0 | 0 |
| C2 | 90.0 | 0 | 0 | 0 | 10.0 | 0 |
| C3 | 93.0 | 0 | 0 | 0 | 6.0 | 1.0 |
| C4 | 0 | 94.0 | 0 | 0 | 6.0 | 0 |
| C5 | 0 | 0 | 94.0 | 0 | 6.0 | 0 |
| C6 | 0 | 0 | 0 | 94.0 | 6.0 | 0 |

The origins of the compounds of Table 1 are as follows:
Polymer A1 is a copolymer of ethylene and methacrylic acid sold by DuPont under the reference Nucrel® 0910. This copolymer comprises approximately 8.6% by weight of carboxyl functional groups, has a melting point (i.e., molten state) of the order of 100° C. and has a melt flow index of 10 in grams/10 minutes, according to Standard ASTM D 1238 at 190° C./2.16 kg.
Polymer A2 is a copolymer of ethylene and acrylic acid sold by Dow under the reference Primacor® 3150. This copolymer comprises approximately 3.0% by weight of carboxyl functional groups, has a melting point (i.e., molten state) of the order of 104° C., and has a melt flow index of 11 in grams/10 minutes, according to Standard ASTM D 1238 at 190° C./2.16 kg.
Polymer A3 is a copolymer of ethylene and acrylic acid sold by Dow under the reference Primacor® 3340. This copolymer comprises approximately 6.5% by weight of carboxyl functional groups, has a melting point (i.e., molten state) of the order of 101° C. and has a melt flow index of 9 in grams/10 minutes, according to Standard ASTM D 1238 at 190° C./2.16 kg.
Polymer A4 is a copolymer of ethylene and acrylic acid sold by Dow under the reference Primacor® 3440. This copolymer comprises approximately 9.7% by weight of carboxyl functional groups, has a melting point (i.e., molten state) of the order of 98° C. and has a melt flow index of 10 in grams/10 minutes, according to Standard ASTM D 1238 at 190° C./2.16 kg.
Agent B is the crosslinking agent 1,3-PBO having a melting point of the order of 148° C.
Catalyst is a crosslinking catalyst of the DBTL type sold by Solvay Padanaplast under the reference Catalyst CT/5.

The compositions collated in Table 1 are processed as follows.

In a first step, for each composition (C1 to C6), the crosslinking agent B is mixed with the polymer A in the molten state in a single-screw extruder of Brabender type.

The length of the screw is 475 mm and its diameter is 19 mm (i.e., L=25D).

The temperature profile of the extruder is mentioned in Table 2 below.

TABLE 2

| | | Zone 1 of | Zone | Zone | Zone 4 at |
|---|---|---|---|---|---|
| | Rate | introduction | 2 | 3 | the extruder |
| Composition | (m/min) | (° C.) | (° C.) | (° C.) | outlet (° C.) |
| Ref1 | 0.8 | 148 | 158 | 165 | 164 |
| C1 | 1.03 | 149 | 166 | 164 | 160 |
| C2 | 1.03 | 149 | 166 | 164 | 160 |
| C3 | 1.07 | 166 | 182 | 178 | 186 |
| C4 | 1.03 | 145 | 157 | 164 | 168 |
| C5 | 1.03 | 145 | 157 | 164 | 168 |
| C6 | 1.03 | 145 | 157 | 164 | 168 |

The rate shown in Table 2 is the extrusion rate.

The compositions of Table 1 are thus extruded as a layer in strip form according to the extrusion characteristics mentioned in Table 2. The thickness of the strips is 2.0 mm.

Of course, the extrusion can advantageously be carried out as a layer surrounding an elongated electrically conducting component in order to form a cable but the characterization of the mechanical properties (of the filler-free electrically insulating compositions according to the invention) in the strip form is sufficient.

At the outlet of the extruder, the extruded layers C1 to C6 in the strip form are not crosslinked and have a gel content of the order of 0%.

As the extruded layer Ref1 does not comprise a crosslinking agent, it thus cannot be crosslinked.

In a second step, the extruded layers C1 to C6 are crosslinked by supplying heat.

According to a first alternative form (V1), the extruded layers C1 to C3 in the strip form are crosslinked at a temperature of at least 90° C. for several hours, in particular for 24 hours. More particularly, the extruded layers C1 to C3 are crosslinked at 95° C. for 6 hours and then at 115° C. for 18 hours, at atmospheric pressure, using a standard oven sold by Heraeus.

According to a second alternative form (V2), the extruded layers C1 to C3 in the strip form are crosslinked at a temperature of 70° C. for several hours, in particular for 117 hours, at atmospheric pressure, using a standard oven sold by Heraeus.

According to a third alternative form (V3), the extruded layers C4 to C6 in the strip form are, for their part, crosslinked at a temperature of 280° C. for several minutes, in particular for 5 minutes. More particularly, the extruded layers C4 to C6 are crosslinked at 280° C. under 0 bar for 3 minutes and then at 280° C. under 10 bar for 2 minutes, using a conventional heating press. They are subsequently cooled under 10 bar for 2 minutes.

Table 3 below brings together:
the gel content, carried out according to Standard ASTM D2765-01 with extraction with xylene,
the results of the tensile strength tests, carried out according to Standard NF EN 60811-1-1,
the results of the elongation at break tests, carried out according to Standard NF EN 60811-1-1, and
the hot creep under load and set results, according to Standard NF EN 60811-2-1.

Standard NF EN 60811-2-1 describes the measurement of the hot creep of a material under load. The corresponding test is commonly denoted the hot set test. It consists in practical terms in weighing down one end of a test specimen of material with a weight corresponding to the application of a stress equivalent to 0.2 MPa and in placing the assembly in a heated oven at 200+/−1° C. for a period of time of 15 minutes. At the end of this time, the hot elongation under load of the test specimen, expressed as %, is recorded. The suspended weight is then removed and the test specimen is kept in the oven for a further 5 minutes. The remaining permanent elongation, also known as set, is then measured before being expressed as %. It should be remembered that the more crosslinked the material, the lower the elongation and set values. Furthermore, it is specified that, in the case where a test specimen happens to break during a test, under the joint action of the mechanical stress and the temperature, the result of the test would then logically be regarded as a failure.

In the present invention, the tensile strength is preferably at least 12.5 N/mm² and the elongation at break is preferably at least 200%, these mechanical properties being determined according to Standard NF EN 60811-1-1.

In the present invention, the hot elongation at break under load is preferably less than 175% and the set is preferably less than 15%, these properties being determined according to Standard NF EN 60811-2-1.

TABLE 3

| | | | | |
|---|---|---|---|---|
| Composition | Ref1 | C1 | C2 | C3 |

Crosslinking: Alternative form V1

| | | | | |
|---|---|---|---|---|
| Gel content (%) | 0 | 93 | 93 | 92 |
| Tensile strength (N/mm²) | 24.5 | 22.1 | 21.1 | 19.8 |
| Elongation at break (%) | 499 | 257 | 263 | 236 |
| Hot elongation at break | Failure | 20 | 10 | 20 |
| under load (%) | | | | |
| Set (%) | Failure | 0 | 0 | 0 |

TABLE 4

| | | | |
|---|---|---|---|
| Composition | C1 | C2 | C3 |

Crosslinking: Alternative form V2

| | | | |
|---|---|---|---|
| Tensile strength (N/mm²) | 28.2 | 28.8 | 22.7 |
| Elongation at break (%) | 347 | 339 | 263 |
| Hot elongation at break | 10 | 15 | 10 |
| under load (%) | | | |
| Set (%) | 0 | 0 | 0 |

TABLE 5

| | | | |
|---|---|---|---|
| Composition | C4 | C5 | C6 |

Crosslinking: Alternative form V3

| | | | |
|---|---|---|---|
| Gel content (%) | 92 | 93 | 96 |
| Tensile strength (N/mm²) | 18.8 | 18.2 | 18.8 |
| Elongation at break (%) | 383 | 222 | 193 |
| Hot elongation at break | 20 | 10 | 10 |
| under load (%) | | | |
| Set (%) | 0 | 0 | 0 |

It is clearly apparent that the layers of the invention are completely crosslinked, while exhibiting very good mechanical properties of the tensile strength and elongation at break type, the latter being greater than 200%.

1. Electrical device comprising:
a crosslinked layer intended to surround or surrounding an elongated electrically conducting component, wherein the crosslinked layer is obtained from a polymer composition having:
at least one olefin polymer (A), and
a crosslinking agent (B) having one or more oxazoline functional groups,
the polymer A having one or more reactive functional groups capable of reacting with the oxazoline functional group of the crosslinking agent B.

2. Device according to claim 1, wherein the polymer composition has more than 50 parts by weight of polymer A per 100 parts by weight of polymer(s) in the composition.

3. Device according to claim 1, wherein the polymer A is not a polyacrylate.

4. Device according to claim 1, wherein the polymer A is not a polyimide.

5. Device according to claim 1, wherein the reactive functional group is a carboxyl functional group.

6. Device according to claim 1, wherein the polymer A has at most 20% by weight of reactive functional group, with respect to the total weight of the polymer A.

7. Device according to claim 1, wherein the polymer A is an olefin polymer having said reactive functional groups grafted to the macromolecular chain of said polymer.

8. Device according to claim 1, wherein the polymer A is a copolymer of olefin and of a monomer carrying the reactive functional group.

9. Device according to claim 8, wherein the polymer A is a copolymer of ethylene and of acrylic or methacrylic acid.

10. Device according to claim 1, wherein the polymer composition has at least 40% by weight of polymer A, with respect to the total weight of the polymer composition.

11. Device according to claim 1, wherein the crosslinking agent is a polymeric compound or a nonpolymeric compound.

12. Device according to claim 11, wherein the polymeric compound is a copolymer functionalized with oxazoline functional groups.

13. Device according to claim 11, characterized in that the nonpolymeric compound comprises at least two oxazoline functional groups.

14. Device according to claim 13, wherein the nonpolymeric compound is chosen from 2,2′-(1,3-phenylene)bis(2-oxazoline), 2,2′-(1,4-phenylene)bis(2-oxazoline) and 2,2′-(2,6-pyridylene)bis(2-oxazoline).

15. Device according to claim 1, wherein the composition has less than 10 parts by weight of fluoropolymer per 100 parts by weight of polymer(s) in the composition.

16. Device according to claim 1, wherein the crosslinked layer is chosen from the group consisting of an electrically insulating layer, a semiconducting layer, a stuffing component and a protective sheath.

17. Device according to claim 1, wherein said device is an electric cable having said crosslinked layer surrounding the elongated electrically conducting component.

18. Device according to claim 17, wherein the crosslinked layer is an extruded layer.

19. Device according to claim 17, wherein said device has a first semiconducting layer surrounding the elongated electrically conducting component, an electrically insulating layer surrounding the first semiconducting layer, and a second semiconducting layer surrounding the electrically insulating layer, the crosslinked layer being at least one of these three layers.

20. Device according to claim 1, wherein said device is an electric cable accessory, intended to surround or surrounding an elongated electrically conductive component of an electric cable, comprising the crosslinked layer.

21. Process for the manufacture of an electric cable according to claim 17, wherein the process comprises the following stages:
i. extruding the polymer composition around the elongated electrically conducting component, in order to obtain an extruded layer, and
ii. crosslinking the extruded layer of stage i.
